(19) United States
(12) Patent Application Publication
(10) Pub. No.: US 2007/0191041 A1
(43) Pub. Date: Aug. 16, 2007

(54) Frequency Allocation

(76) Inventor: John M. Chapin, Arlington, MA (US)

Correspondence Address: FISH & RICHARDSON PC, P.O. BOX 1022, MINNEAPOLIS, MN, 55440-1022, US

(21) Appl. No.: 11/675,302

(22) Filed: Feb. 15, 2007

Related U.S. Application Data
(60) Provisional application No. 60/773,892, filed on Feb. 16, 2006.

(51) Int. Cl. H04Q 7/20; H04B 7/00

(52) U.S. Cl. 455/509; 455/450

(57) ABSTRACT

Methods and systems for allocating mobiles among multiple frequency channels in a mobile communications system are disclosed.

### PRIORITY TO OTHER APPLICATIONS

This application claims priority from and incorporates herein U.S. Provisional Application No. 60/773,892, filed Feb. 16, 2006 and titled “Methods and Systems for Reducing Interference Flux”.

### TECHNICAL FIELD

The following description relates to methods and systems for allocation of mobiles among multiple frequency channels in a mobile communications system.

### BACKGROUND

In a satellite based communication system, a mobile unit, such as a mobile telephone or wireless handheld device, can communicate directly with the satellite and/or can communicate with an Ancillary Terrestrial Component (ATC) that operates using the same frequency band as the satellite. For example, an ATC can be installed near major metropolitan areas to help satellite service companies overcome gaps created when the satellite signals are blocked by buildings and other obstacles.

### SUMMARY

In some aspects, a method includes allocating mobile devices among multiple channels of a radio frequency wireless system based on a variable associated with the transmission power of the mobile devices. The multiple channels are assigned to different portions of a frequency band.

In some aspects, a method can include moving at least one mobile device from a first channel of a base station to a second channel of the base station based on a variable associated with the transmission power of the mobile device. The base station can be a radio frequency wireless system infrastructure component through which the mobile is communicating. The first channel can be assigned to a first portion of a frequency band and the second channel can be assigned to a second portion of the frequency band, the first portion being different from the second portion.

Embodiments can include one or more of the following.

The first portion of the frequency band can be a frequency range used by the base station to communicate with mobile devices. The second portion of the frequency band can be a frequency range not used by the base station to communicate with the mobile devices. The variable associated with the transmission power of the mobile device can be an estimate of a current transmission power of the mobile device. The variable associated with the transmission power of the mobile device can be an estimate of an average transmission power of the mobile device. The variable associated with the transmission power of the mobile device can be an estimated distance. The estimated distance can be an estimated distance between a location of the mobile device and a location of the base station through which the mobile is communicating. The variable associated with the transmission power of the mobile device can be an estimated transmission power. The variable associated with the transmission power of the mobile device can be an estimated signal-to-noise ratio of the signal sent by the base station to the mobile.

The method can also include determining an estimated aggregate power of the mobile devices operating on the first channel and determining a relationship between the estimated aggregate power and a threshold. The method can also include moving a different mobile from the second channel of the base station to the first channel of the base station based on a variable associated with the transmission power of the different mobile. The method can also include sorting a mobiles operating in the first channel according to transmission power settings for the mobiles. The method can also include sorting a plurality of mobiles operating in the second channel according to transmission power settings for the mobiles. The first channel can be assigned to a portion of the frequency band covered by a receiver. The second channel can be assigned to a portion of the frequency band not covered by the receiver.

Moving the at least one mobile from the first channel of the base station to the second channel of the base station can include selecting one or more mobiles from the first channel having the highest transmission power settings and moving the one or more mobiles having the highest transmission power settings from the first channel to the second channel. Moving the different mobile from the second channel of the base station to the first channel of the base station can include selecting one or more mobiles from the second channel having the lowest transmission power settings and moving the one or more mobiles having the lowest transmission power settings from the second channel to the first channel.

In some aspects, a method can include determining an estimated aggregate power of a plurality of mobiles operating on a first channel that is assigned to a first portion of a frequency band and determining a relationship between the estimated aggregate power and a threshold. If the relationship between the estimated aggregate power and the threshold meets a condition, the method can include sorting mobiles operating on the first channel according to a variable associated with a transmission power and moving at least one mobile from the first channel to a second channel based on the variable associated with the transmission power. The second channel can be assigned to a second portion of the frequency band that is different from the first portion of the frequency band. The method can also include sorting mobiles operating on a second channel according to the variable associated with the transmission power and moving at least one mobile from the second channel to the first channel based on the variable associated with the transmission power.

In some aspects, an apparatus can include circuitry to assign a first channel of a base station to a first portion of a frequency band, assign a second channel of a base station to a second portion of a frequency band, and move at least one mobile device from the first channel of the base station to the second channel of the base station based on a variable associated with the transmission power of the mobile device.

Embodiments can include one or more of the following.

The variable associated with the transmission power of the mobile device can be an estimate of a current transmission power of the mobile device, an estimate of an average transmission power of the mobile device, an estimated distance, and/or an estimated signal-to-noise ratio of the signal sent by the base station to the mobile.

The apparatus can also include circuitry to sort mobiles operating in the first channel according to transmission power settings for the mobiles. The apparatus can also include circuitry to sort a plurality of mobiles operating in the second channel according to transmission power settings for the mobiles. The first channel can be assigned to a portion of the frequency band covered by a receiver. The second channel can be assigned to a portion of the frequency band not covered by the receiver. The apparatus can also include circuitry to select one or more mobiles from the first channel having the highest transmission power settings, move the one or more mobiles having the highest transmission power settings from the first channel to the second channel, select one or more mobiles from the second channel having the lowest transmission power settings, and move the one or more mobiles having the lowest transmission power settings from the second channel to the first channel.

In some aspects, an article can include a machine-readable medium that stores executable instructions causing a machine to assign a first channel of a base station to a first portion of a frequency band, assign a second channel of a base station to a second portion of a frequency band, and move at least one mobile device from the first channel of the base station to the second channel of the base station based on a variable associated with the transmission power of the mobile device.

Embodiments can include one or more of the following.

The variable associated with the transmission power of the mobile device can be an estimate of a current transmission power of the mobile device, an estimate of an average transmission power of the mobile device, an estimated distance, and/or an estimated signal-to-noise ratio of the signal sent by the base station to the mobile.

The article can also include instructions to sort mobiles operating in the first channel according to transmission power settings for the mobiles. The article can also include instructions to sort a plurality of mobiles operating in the second channel according to transmission power settings for the mobiles. The first channel can be assigned to a portion of the frequency band covered by a receiver. The second channel can be assigned to a portion of the frequency band not covered by the receiver. The article can also include instructions to select one or more mobiles from the first channel having the highest transmission power settings, move the one or more mobiles having the highest transmission power settings from the first channel to the second channel, select one or more mobiles from the second channel having the lowest transmission power settings, and move the one or more mobiles having the lowest transmission power settings from the second channel to the first channel.

### BRIEF DESCRIPTION OF THE DRAWINGS

FIG. 1 is a block diagram of a communication system.

FIG. 2 is a flow chart of a frequency allocation process.

FIG. 3 is a flow chart of a frequency allocation process.

FIG. 4 is a flow chart of a weather based frequency allocation process.

FIG. 5 is a diagram of a weather map.

FIG. 6 is a block diagram of an ATC and areas surrounding the ATC.

FIG. 7 is a flow chart of a frequency allocation process.

FIG. 8 is a diagram of a cellular coverage map.

### DESCRIPTION

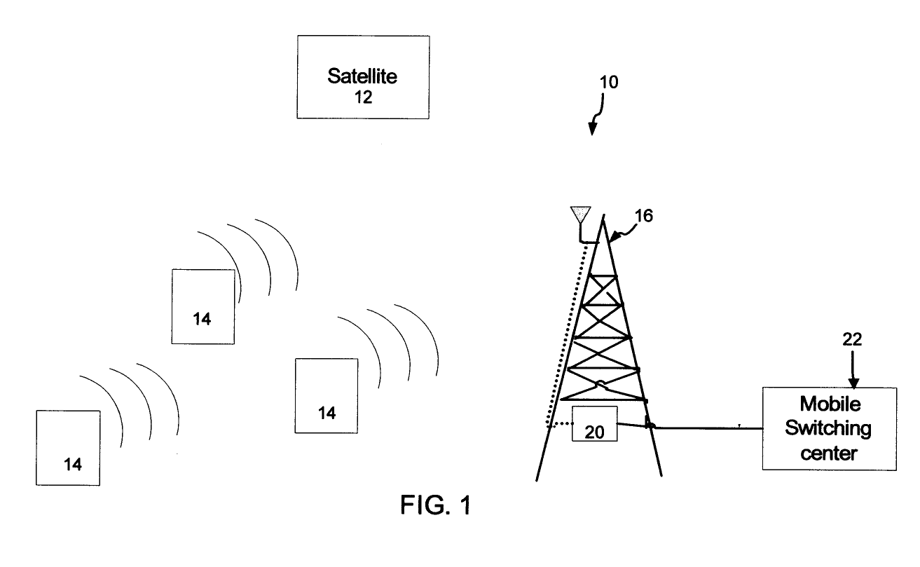

As shown in FIG. 1, in a communication system 10, voice, data, and signaling traffic is sent between mobile devices 14 (e.g., mobile telephones, personal data assistants, wireless data transfer devices, wireless computers, etc.) and a satellite 12 and/or an Ancillary Terrestrial Component (ATC) 20. The mobile unit's proximity to the ATC 20 can be used to determine whether the mobile unit 14 communicates with the ATC 20 or the satellite 12. If the traffic from a mobile unit 14 is received by the ATC 20, the traffic is backhauled from the ATC 20 at the cell tower site 16 to a mobile switching center 22. If the traffic from the mobile unit 14 is received by the satellite 12, the satellite 12 sends a signal to the mobile switching center 22 that routes the traffic to other devices.

The satellite 12 can operate within a particular frequency band assigned to the communication system 10. However, as discussed below, the communications between the mobile devices 14 and the satellite 12 can be limited to a portion of less than the total frequency band assigned to the communication system 10. The ATC 20 sends and receives signals from the mobile devices 14 using the same frequency band as the frequency band assigned to the communication system 10. The frequency band used by the ATC 20 is divided into at least two traffic channels having different frequency ranges that are within the frequency band assigned to the communication system 10. A first traffic channel is assigned in the portion of the frequency band used by the satellite 12 to communicate with the mobile devices 14 (also referred to as a satellite interfering channel) and a second traffic channel is assigned to a portion of the frequency band outside of the frequency band used by the satellite 12 to communicate with the mobile devices 14.

Mobile devices that communicate with the ATC 20 on the same frequency band as the mobile devices 14 use to communicate with the satellite 12 can cause interference at the satellite 12. The amount of interference observed by the satellite 12 is based on an aggregate power of the mobile devices operating on the same frequency channel as the frequency channel the mobile devices 14 use to communicate with the satellite 12. It is believed that interference flux to the satellite 12 can be reduced by limiting the aggregate transmission (TX) power of mobile devices operating in the satellite-interfering channel. In general, for communications between the mobile 14 and the ATC 20, the location of the mobile 14 and/or the surrounding conditions (e.g., proximity to buildings, weather, terrain and mobility) affects the transmission power used by the mobile 14 to communicate with the ATC 20. In order to limit the maximum aggregate power of the mobile devices 14 operating in the satellite interfering channel, mobile devices 14 using higher transmission powers can be switched from the interfering channel of the ATC 20 to a non-interfering channel on the same ATC 20 (also referred to as hopping).

In general, the interference flux observed by the satellite 12 is associated with the total or aggregate power of mobile devices 14 operating in the interfering channel and not the power of an individual mobile in the interfering channel. Thus, the interference flux to the satellite 12 can be reduced by limiting the aggregate power of mobile devices 14 operating in the portion of the frequency band used by the satellite 12 to communicate with other mobile devices (as opposed to limiting the maximum transmission power of any one mobile 14). The system aggregates the transmission power of the mobile devices 14 on a particular channel based on a summation of an estimated power flux of each mobile, integrated over time. In order to reduce the interference, the mobile devices generating more power over more time are moved to the non-interfering channel(s). By moving mobile devices based on overall power flux, even if the power flux of an individual mobile is below a hard cutoff power, the system reduces aggregate power flux and generates more headroom for other ATC cells that have a lot of mobile devices at higher transmission powers in the satellite-interfering channel.

In some embodiments, hopping mobile devices using a higher transmission power into the non-interfering channel may have quality of service (QOS) impacts by limiting maximum transmission power for mobile devices. For example, since the interference flux is based on aggregate power, the transmission power for the mobile 14 may not need to be limited in a situation where there is not enough total mobile 14 to ATC 20 traffic to cause interference problems in the satellite 12. In another example, the transmission power for the mobile 14 may not need to be limited in a situation where a mobile 14 in the low-power channel drops temporarily into a deep null and temporarily transmits at a high transmission power level.

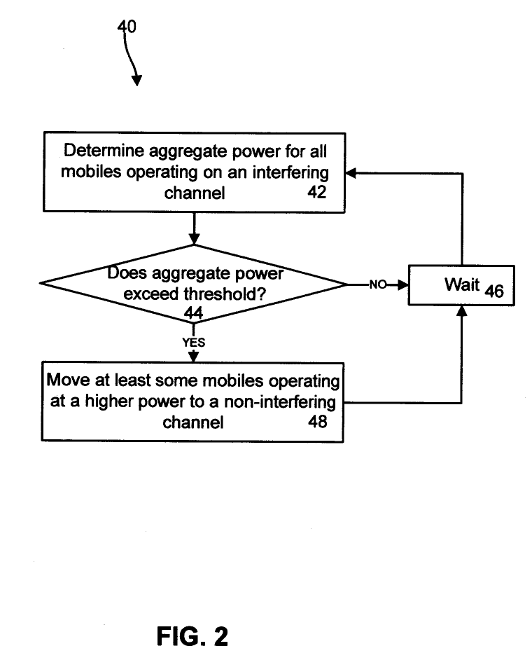

Referring to FIG. 2, a process 40 for allocating mobile devices 14 among multiple, different frequency channels of the ATC 20 is shown. The ATC 20 determines the aggregate power for all mobile devices on a channel that interferes with the satellite (42). The ATC 20 determines if the aggregate power for the mobile devices on the interfering channel is above a threshold (44). If the aggregate power is not above the threshold, it is not necessary to move mobile devices from the interfering channel to another channel and the system waits a predetermined period of time before re-determining the aggregate power of the mobile devices on the interfering channel (46). If the aggregate power is above the threshold, the ATC 20 moves at least some of the mobile devices from the interfering channel to a non-interfering channel in order to reduce the potential interference flux on the satellite 12 generated by the mobile devices 14 operation on the interfering channel (48). After moving the mobile devices 14, the ATC 20 waits a predetermined period of time before re-determining the aggregate power of the mobile devices on the interfering channel (46).

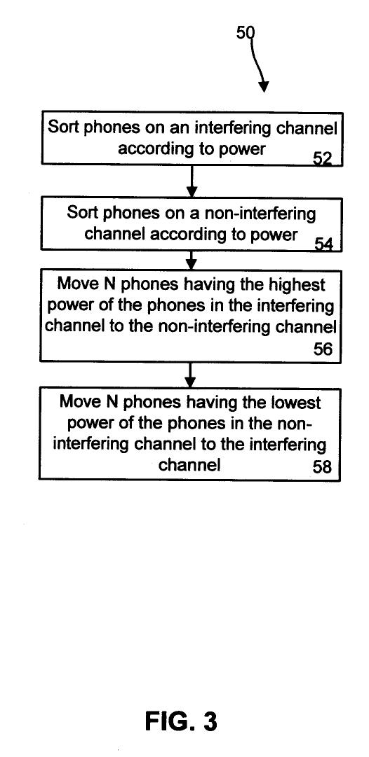

Referring to FIG. 3, an exemplary process 50 for moving the mobile devices 14 from the interfering channel to a non-interfering channel in order to reduce the potential interference flux on the satellite 12 is shown. In order to move the mobile devices on the interfering channel to a non-interfering channel based on overall power flux, the ATC 20 sorts the mobile devices 14 operating on the interfering channel based on the transmission power of the mobile devices 14 (52). The ATC 20 also sorts the mobile devices 14 operating on the non-interfering channel based on the transmission power of the mobile devices 14 (54). For example, in order to sort the mobile devices 14 on the interfering and non-interfering channels, the system can track the power integral over time by using a decaying average or similar function. The input to the decaying average in each time slot will be a function of the transmission power setting for the mobile. For example, the system can use the square of the power level. In other examples, the system analytically computes the transfer function that best matches the satellite interference contribution from that mobile. (If different classes of devices have different contributions at the same power level, due to antenna design or usage patterns, the system can use different transfer functions for the different devices in the system.) Since there are relatively few power levels, in some embodiments, a lookup table can use used to represent the desired transfer function.

The system periodically (every 3 seconds, every 5 seconds, every 7 seconds, every 10 seconds, every 20 seconds) compares the transmission power of the top N (e.g., two, three, four, five, etc.) mobile devices 14 in the lower-power, interfering channel with the bottom N (e.g., two, three, four, five, etc.) mobile devices in the higher-power, non-interfering channel. The system moves up to N (e.g., two, three, four, five, etc.) mobile devices having the highest power of the mobile devices 14 in the interfering channel (e.g., the lower power channel) to the non-interfering channel (e.g., the higher power channel) to reduce the aggregate power of the mobile devices in the interfering channel (56). The system also optionally moves N mobile devices 14 having the lowest power of the mobile devices 14 in the non-interfering channel (e.g., the higher power channel) to the interfering channel (e.g., the lower power channel) (58). In some embodiments, a high hysteresis can be used to avoid hopping a mobile between the non-interfering channel and the interfering channel too frequently.

In some embodiments, the system determines whether to move any devices from the interfering channel to the non-interfering channel based on the comparison of the transmission power of the top N mobile devices 14 in the interfering channel with the bottom N mobile devices in the non-interfering channel. For example, if the transmission power of the top N mobile devices 14 in the interfering channel is less than the transmission power of the bottom N mobile devices in the non-interfering channel, the system can determine not to swap the top N mobile devices 14 in the interfering channel with the bottom N mobile devices in the non-interfering channel because performing such a swap would increase the aggregate power on the interfering channel.

In some embodiments, the number (N) of mobile devices to move from the interfering channel to the non-interfering channel and from the non-interfering channel to the interfering channel can be based on the comparison of the transmission powers of mobile devices 14 in the interfering channel with mobile devices in the non-interfering channel. For example, N can be selected such that the transmission power of the mobile having the Nth lowest transmission power of the mobile devices in the non-interfering channel is less than the transmission power of the mobile device having the greatest transmission power in the interfering channel.

This frequency allocation scheme can be generalized to more than two channels where appropriate. For example, the system can observe and swap the top mobile devices in the lower-power, interfering channel with the bottom mobile devices in each of a plurality of higher-power, non-interfering channels. When a system employs several channels, in some embodiments, it may be desirable to transfer the highest power transmitters to those channels having frequencies furthest away from the channels on which the receiver to be protected from interference is operating.

In some embodiments, the integral function can be aggregated across mobile devices in the cell, then across cells in a metro area or other region, and reported periodically to the network operations center. When the Network Operations Centre (NOC) monitoring satellite telemetry or satellite call QOS observes that overall interference flux is too high, this information from all the ATCs enables the Network Operations Center to make intelligent management decisions. For example, the Network Operations Center can selectively or in a non-discriminatory fashion reduce interference flux by reducing capacity on the terrestrial or satellite portions of the system or by determining which mobiles contribute most to the interference flux and temporarily suspending service to such mobiles until overall interference has decreased or until, in each case, the relevant mobile is capable of communicating with the system at lower power.

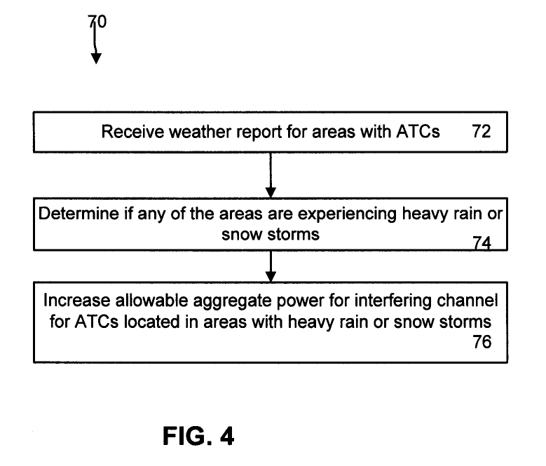

Referring to FIG. 4, in some embodiments, the allocation of mobile devices between the interfering and non-interfering channels can be based in part on weather conditions. For example, in certain weather conditions such as heavy rain or snow, the amount of interference flux observed by the satellite from a mobile 14 is reduced due to atmospheric absorption. When weather conditions exist resulting in high atmospheric absorption, the aggregate power of mobile devices operating in the interfering channel of the ATC 20 that can be acceptable without generating too great of interference flux on the satellite 12 can be greater than when the atmospheric absorption is low.

FIG. 4 shows a process 70 for determining an acceptable aggregate power for an interfering channel of an ATC 20 based on weather conditions in the proximity of the ATC 20. The system receives weather reports for areas with ATC towers (72). For example, the system can receive weather reports for major cities in which ATCs are located. The system determines if any of the areas are experiencing heavy rain storms, snow storms, or other weather that would result in high atmospheric absorption (74). If any of the areas are experiencing such weather conditions, the system increases the allowable aggregate power for the interfering channel for the ATC(S) located in the area (76).

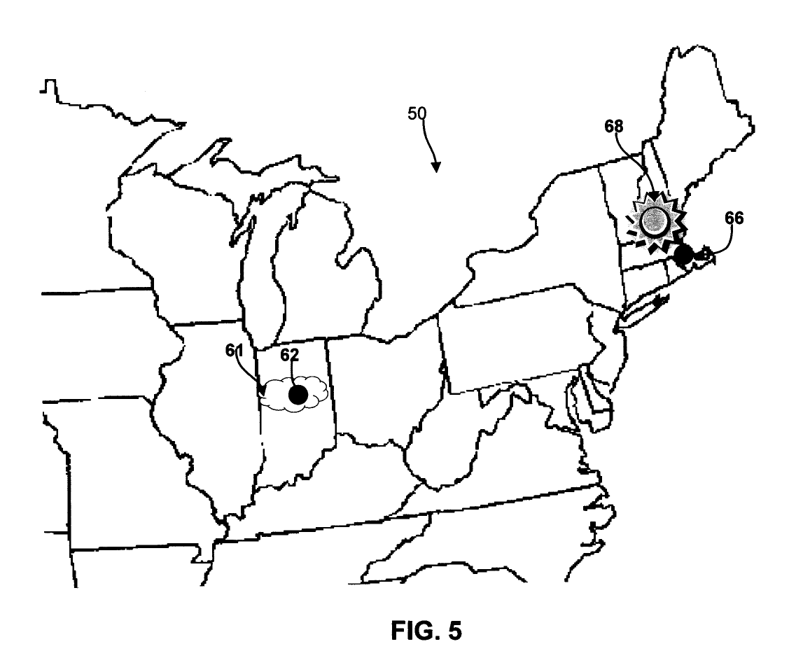

For example, as shown in FIG. 5, a weather report indicates that the Indianapolis area 62 is experiencing a major rainstorm (as indicated by rain cloud 64) while the Boston area 66 is experiencing sunshine and clear skies (as indicated by clear sky 68). Due to the rainstorm in Indianapolis, a high number of ATC mobile devices 14 in Indianapolis area 62 may be operating at high transmission power in the satellite interfering channel. Due to the rainstorm, the transmission power of the mobile devices in the Indianapolis area may be needed to close the communication link between the ATC 20 and the mobile 14 and enable communication between the mobile devices 14 and the ATC 20. It is believed that these transmissions between the mobile devices 14 and the ATC 20 won't be contributing much to interference flux at the satellite 12 due to high atmospheric absorption. In contrast, in the Boston area 66, mobile devices operating at high transmission power are likely to contribute more to the interference flux on satellite 12 because there will not be high atmospheric absorption.

When the system needs to reduce overall interference flux observed by the satellite 12, it can select metropolitan areas or regions where there is a lot of satellite-interfering transmission power and where mitigating weather or other conditions do not exist. For example, the maximum aggregate transmission power for ATCs in the Boston area could be less than the maximum aggregate transmission power for ATCs in the Indianapolis area. Given that selection, a control command sent to all those ATCs 20 can selectively limit the maximum aggregate transmission power in the interfering channels. The limit can be moved up or down as needed to get into the proper operating region for the satellite. There will be some ATC QOS reduction as a result of these limits for those mobile devices that can't be moved to the non-interfering channels due to capacity constraints and that are experiencing fades, but this will be the minimum QOS impact needed to ensure the satellite functions well.

While in some of the embodiments discussed above the channel allocation is based on the aggregate power of mobile devices on the interfering channel, other factors associated with the aggregate power can be used. Exemplary factors associated with transmit power of a mobile and thus the aggregate power on a channel used by that mobile that could be used to allocate the mobile devices among the interfering and non-interfering channels include distance from the ATC, mobile location, and power or signal-to-noise ratio of the signal sent by the ATC to the mobile.

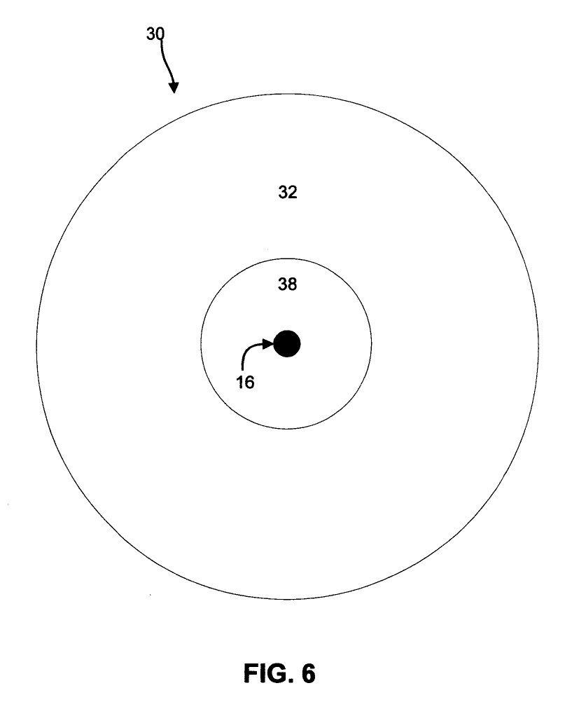

For example, in some embodiments, the average distance of the mobile 14 from the ATC 20 can be used to determine which mobile devices to move between the interfering channel and the non-interfering channel. It is believed that, in some circumstances, the power used by the mobile to communicate with the ATC 20 is proportional to the distance the mobile is from the ATC 20 (e.g., the further the mobile 14 is from the ATC 20 the higher power used to communicate with the ATC 20). Thus, as shown in FIG. 6, in order to reduce the aggregate power on the interfering channel, the mobile devices 14 in an area 38 closest to the ATC 16 can be allocated to the interfering channel while mobile devices 14 in an area 32 of greater distance from the ATC 20 can be allocated to a non-interfering channel.

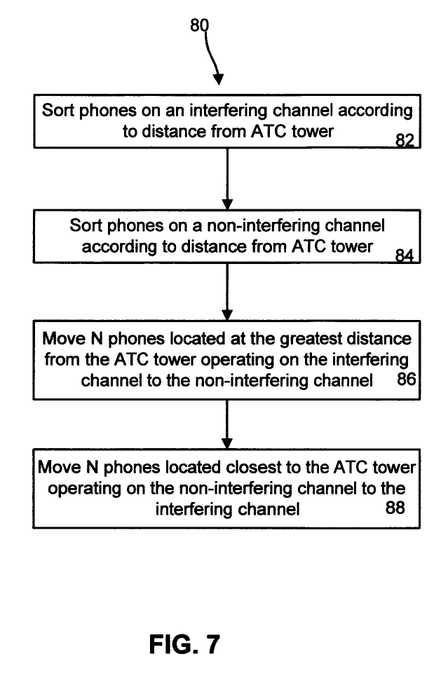

FIG. 7 shows a process 80 for allocating mobile devices 14 to the interfering/non-interfering channels based on the distance of the mobile devices 14 from the ATC 20 in order to reduce the potential interference flux on the satellite. In order to move the mobile devices on the interfering channel to a non-interfering channel based on distance from the ATC 20, the ATC 20 sorts the mobile devices operating on the interfering channel based on the distance from the ATC 20 (82). The ATC 20 also sorts the mobile devices operating on the non-interfering channel based on the distance from the ATC 20 (84). The system periodically (every 3 seconds, every 5 seconds, every 7 seconds, every 10 seconds, every 20 seconds) compares the distance from the ATC 20 of the top N (e.g., two, three, four, five, etc.) mobile devices in the lower-power channel with the distance from the ATC 20 of the bottom N (e.g., two, three, four, five, etc.) mobile devices in the higher-power channel. The system moves N mobile devices having the greatest distance of the mobile devices in the interfering channel to the non-interfering channel (86). The system also moves N mobile devices having the shortest distance of the mobile devices in the non-interfering channel to the interfering channel (88). In some embodiments, a high hysterisis can be used to avoid hopping a mobile too frequently.

In another example, the power or signal to noise ratio of the transmissions of the ATC may be measured by the mobile and reported to the ATC. If these reports indicated that the power or signal to noise ratio of the ATC as received by the mobile is high, then the mobile likely need not transmit at high power to complete the link from the mobile to the ATC. Such a mobile can be allocated to the interfering channel, since its lower power transmissions are less likely to create harmful additional interference flux.

Further, in some embodiments, customers who pay for a higher level of service can be exempted from transmission limitations irrespective of the channel they are operating in (e.g., irrespective of whether the mobile is operating in the interfering channel or the non-interfering channel). As long as the number of such customers is not too great, it is believed that there will be enough of operational flexibility to maximum-limit transmission power of other mobile devices and keep the interference flux on satellite 12 down to acceptable levels.

This scheme also allows the incorporation of single-channel cell sites that, for frequency planning reasons, operate in the satellite-interfering portion of the band. The system does not need to hard-limit mobile transmission power and potentially hurt the QOS of mobile devices in such cells. Instead, the satellite interference flux created by that cell will automatically be compensated for by overall sorting across the whole region, and by transmission power reductions across the region if that becomes necessary.

In some embodiments, in addition to limiting max transmission power when satellite interference flux is too high, the network operations center could additionally/alternatively have all mobile devices in a region operate at some delta of power control below where the mobile would normally operate according to the standard operating procedure of the waveform. So all mobile devices operate at a power setting that is one or two power steps below optimum. In some situations, this may result in the mobile operating at lower data rates. For example, this approach could be used if the cumulative effect of many lower-power mobile devices drives the interference to the satellite, rather than the effect of the relatively small number of mobile devices who are forced to TX at high power due to a fade.

In some embodiments, some classes of users who pay a premium might be exempted from this throttling, or might be throttled less than other users, or might be throttled only if throttling everyone else doesn't sufficiently reduce the interference flux.

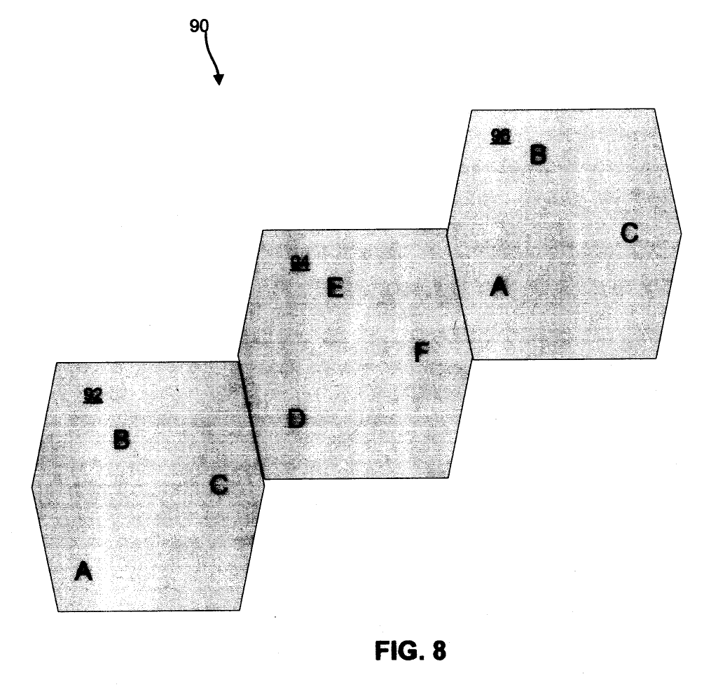

While in embodiments described above, the mobile devices 14 are allocated between frequencies that interfere or don't interfere with the operation of a satellite 12, the allocation of a mobile could be used in general to limit interference to receivers and is not limited to interference on a satellite. For example, as shown in FIG. 8, a cellular system can include multiple regions 92, 94, and 96 each including a cellular base station that can communicate with mobile devices on multiple frequency channels. For example, the base station that covers region 92 communicates with mobile devices using three different frequencies A, B, and C, the base station that covers region 94 communicates with mobile devices using frequencies D, E, and F, and the base station that covers region 96 communicates with mobile devices using frequencies A, B, and C. The frequencies used by the base stations are repeated in non-adjacent regions in order to maximize available bandwidth through reuse of spectrum while minimizing interference. However, due to the use of the same frequency among multiple different base stations, the communications between mobile devices with one base station may interfere with the communications of other mobile devices with a different base station. If the communications between mobile devices in one area interfere with mobile devices in another area, the power of the mobile devices assigned to communicate on the particular frequency channel could be limited in order to reduce the interference observed in the other area.

For example, if the mobile devices communicating on channel A in region 92 are generating interference on channel A for region 96, then the aggregate power of the mobile devices allocated to channel A in region 92 could be reduced. For example, some of the mobile devices communicating on channel A in region 92 could be moved to channels B and C.

A number of embodiments of the invention have been described. Nevertheless, it will be understood that various modifications may be made without departing from the spirit and scope of the invention.

What is claimed is:

1. A method, comprising:
allocating mobile devices among multiple channels of a radio frequency wireless system based on a variable associated with the transmission power of the mobile devices, the multiple channels being assigned to different portions of a frequency band.

2. A method, comprising:
moving at least one mobile device from a first channel of a base station to a second channel of the base station based on a variable associated with the transmission power of the mobile device, wherein:
the base station comprises a radio frequency wireless system infrastructure component through which the mobile is communicating; and
the first channel is assigned to a first portion of a frequency band and the second channel is assigned to a second portion of the frequency band, the first portion being different from the second portion.

3. The method of claim 2, wherein:
the first portion of the frequency band comprises a frequency range used by the base station to communicate with mobile devices; and
the second portion of the frequency band comprises a frequency range not used by the base station to communicate with the mobile devices.

4. The method of claim 2, wherein the variable associated with the transmission power of the mobile device comprises an estimate of a current transmission power of the mobile device.

5. The method of claim 2, wherein the variable associated with the transmission power of the mobile device comprises an estimate of an average transmission power of the mobile device.

6. The method of claim 2, wherein the variable associated with the transmission power of the mobile device comprises an estimated distance.

7. The method of claim 6, wherein the estimated distance comprises an estimated distance between a location of the mobile device and a location of the base station through which the mobile is communicating.

8. The method of claim 2, wherein the variable associated with the transmission power of the mobile device comprises an estimated transmission power or estimated signal-to-noise ratio of the signal sent by the base station to the mobile.

9. The method of claim 2, further comprising:
determining an estimated aggregate power of the mobile devices operating on the first channel; and
determining a relationship between the estimated aggregate power and a threshold.

10. The method of claim 2, further comprising:
sorting a mobiles operating in the first channel according to transmission power settings for the mobiles, the first channel being assigned to a portion of the frequency band covered by a receiver.

11. The method of claim 10, wherein
moving the at least one mobile from the first channel of the base station to the second channel of the base station comprises:
selecting one or more mobiles from the first channel having the highest transmission power settings; and
moving the one or more mobiles having the highest transmission power settings from the first channel to the second channel.

12. The method of claim 2, further comprising moving a different mobile from the second channel of the base station to the first channel of the base station based on a variable associated with the transmission power of the different mobile.

13. The method of claim 12, further comprising:
sorting a plurality of mobiles operating in the second channel according to transmission power settings for the mobiles, the second channel being assigned to a portion of the frequency band not covered by the receiver.

14. The method of claim 13, further comprising
moving the different mobile from the second channel of the base station to the first channel of the base station comprises:
selecting one or more mobiles from the second channel having the lowest transmission power settings; and
moving the one or more mobiles having the lowest transmission power settings from the second channel to the first channel.

15. A method comprising:
determining an estimated aggregate power of a plurality of mobiles operating on a first channel that is assigned to a first portion of a frequency band;
determining a relationship between the estimated aggregate power and a threshold;
if the relationship between the estimated aggregate power and the threshold meets a condition:
sorting mobiles operating on the first channel according to a variable associated with an transmission power;
moving at least one mobile from the first channel to a second channel based on the variable associated with the transmission power, the second channel being assigned to a second portion of the frequency band that is different from the first portion of the frequency band;
sorting mobiles operating on a second channel according to the variable associated with the transmission power; and
moving at least one mobile from the second channel to the first channel based on the variable associated with the transmission power.

16. An apparatus comprising:
circuitry to:
assign a first channel of a base station to a first portion of a frequency band;
assign a second channel of a base station to a second portion of a frequency band, the second portion being different from the first portion; and
move at least one mobile device from the first channel of the base station to the second channel of the base station based on a variable associated with the transmission power of the mobile device.

17. The apparatus of claim 16, wherein the variable associated with the transmission power of the mobile device comprises a variable selected from the group consisting of an estimate of a current transmission power of the mobile device, an estimate of an average transmission power of the mobile device, an estimated distance, and estimated signal-to-noise ratio of the signal sent by the base station to the mobile.

18. The apparatus of claim 16, further comprising circuitry to:
sort mobiles operating in the first channel according to transmission power settings for the mobiles, the first channel being assigned to a portion of the frequency band covered by a receiver; and
sort a plurality of mobiles operating in the second channel according to transmission power settings for the mobiles, the second channel being assigned to a portion of the frequency band not covered by the receiver.

19. The apparatus of claim 16, further comprising circuitry to:
select one or more mobiles from the first channel having the highest transmission power settings;
move the one or more mobiles having the highest transmission power settings from the first channel to the second channel;
select one or more mobiles from the second channel having the lowest transmission power settings; and
move the one or more mobiles having the lowest transmission power settings from the second channel to the first channel.

20. An article comprising a machine-readable medium that stores executable instructions causing a machine to:
assign a first channel of a base station to a first portion of a frequency band;
assign a second channel of a base station to a second portion of a frequency band, the second portion being different from the first portion; and
move at least one mobile device from the first channel of the base station to the second channel of the base station based on a variable associated with the transmission power of the mobile device.

21. The article of claim 20, wherein the variable associated with the transmission power of the mobile device comprises a variable selected from the group consisting of an estimate of a current transmission power of the mobile device, an estimate of an average transmission power of the mobile device, an estimated distance, and estimated signal-to-noise ratio of the signal sent by the base station to the mobile.

22. The article of claim 20, further comprising instructions to:
sort mobiles operating in the first channel according to transmission power settings for the mobiles, the first channel being assigned to a portion of the frequency band covered by a receiver; and
sort a plurality of mobiles operating in the second channel according to transmission power settings for the mobiles, the second channel being assigned to a portion of the frequency band not covered by the receiver.

23. The article of claim 20, further comprising instructions to:
select one or more mobiles from the first channel having the highest transmission power settings;
move the one or more mobiles having the highest transmission power settings from the first channel to the second channel;
select one or more mobiles from the second channel having the lowest transmission power settings; and
move the one or more mobiles having the lowest transmission power settings from the second channel to the first channel.
